(19) United States
(12) Patent Application Publication
(10) Pub. No.: US 2007/0077364 A1
(43) Pub. Date: Apr. 5, 2007

(54) Method to coat insulation film on aluminum body of electrolytic capacitor

(75) Inventor: Cheng-Huang Lee, Caotun Township (TW)

Correspondence Address: TROXELL LAW OFFICE PLLC, SUITE 1404, 5205 LEESBURG PIKE, FALLS CHURCH, VA, 22041, US

(73) Assignee: ABA CON International Limited

(21) Appl. No.: 11/242,883

(22) Filed: Oct. 5, 2005

(51) Int. Cl. B01J 19/08

(52) U.S. Cl. 427/457

(57) ABSTRACT

A method to coat insulation film on aluminum body of electrolytic capacitor, which is to produce ion beam according to the high potential difference between anode and cathode, or microwave controlled electric field with microwave generator; this ion strikes polytetrafluoroethylene so as to strike out fluorine atom, then gaseous ion substitute it (such as oxygen) and produce skin layer in 10μ˜15μ thick, then adhere to surface of aluminum body, this skin layer is directly coated on surface of aluminum body, which can insulate and protect the aluminum body, so that it needn't be glued with PVC or PET felt plastic film, therefore, this method can coat insulation film quickly and answer to requirements of environmental protection.

### BACKGROUND OF THE INVENTION

### 1. Field of the Invention

This invention relates to a method to coat insulation film on aluminum body of electrolytic capacitor, which applies ion to strike polytetrafluoroethylene in a high vacuum electric field or plasma so as to strike out fluorine atom oxidizing at anode and produce strong adherence accordingly, then deposit on surface of aluminum body and form skin layer which insulate and protect surface of aluminum body, so that this method can coat insulation film quickly and also answer to the requirements of environmental protection.

### 2. Description of the Prior Art

Please refer to FIG. 1 and FIG. 2, according to the current electrolytic capacitor 1, please refer to FIG. 3 for its manufacturing flow, which is manufactured in the following steps: first put aluminum body 11 together with rubber gasket 12, and fill electrolyte 13 into it, then one layer of PVC (polyvinyl chloride) or PET (Polyethylene Terephtalate) felt plastic film 14 is coated on aluminum body 11, conductive feet 15 are respectively connected from electrolyte 13 and aluminum body 11.

### SUMMARY OF THE INVENTION

1. Problems to Solve

1. According to the current invention, aluminum body of electrolytic capacitor is glued with plastic film made of PVC (polyvinyl chloride) or PET (Polyethylene Terephtalate) felt, which is very difficult to coat, furthermore, there is no way to improve its coating quality, its appearance may be also not as good as expected.
2. The plastic film glued on surface of the current aluminum body can not be in conformity with requirements of environmental protection, which may cause the second pollution.
3. To coat aluminum body of electrolytic capacitor with above described PVC or PET plastic film must be packed one by one, therefore, its production cost may be increased due to increase of manufacturing man-hour.
   2. Solutions
1. This invention is to apply ion to strike polytetrafluoroethylene in a high vacuum electric field or plasma so as to strike out fluorine atom oxidizing at anode and produce strong adherence at the same time, then deposit on surface of aluminum body and form skin layer in 10μ˜15μ thick, which may insulate and protect surface of aluminum body, therefore, this coating method can quickly coat surface of aluminum body, and also answer to requirements of environmental protection.
2. The above described coating method of this invention, which can get rid of the step to glue PVC (polyvinyl chloride) or PET (Polyethylene Terephtalate) felt plastic film but coat skin layer on several aluminum bodies once, therefore, it is not only produced very quickly, but also save production cost and improve its appearance and quality.
3. The above described generation of ion, which can produce gaseous ion to strike out fluorine atom from polytetrafluoroethylene based on the high electric potential difference between anode and cathode.
4. The above described generation of ion, which can also apply microwave generator to produce microwave which can control size of the electronic field, so that electron may produce cyclotron resonance discharge and produce high energy ion beam to strike out fluorine atom from polytetrafluoroethylene.

### BRIEF DESCRIPTION OF THE DRAWINGS

FIG. 1 is the manufacturing flow square drawing of aluminum body of the current electrolytic capacitor.

FIG. 2 is the appearance drawing of electrolytic capacitor.

FIG. 3 is cross-section sketch map of the current electrolytic capacitor.

FIG. 4 is the manufacturing flow square drawing of this invention

FIG. 5 is the coating performance sketch map of aluminum body of this invention.

FIG. 6 is the cross-section sketch map of aluminum body of this invention at end of coating.

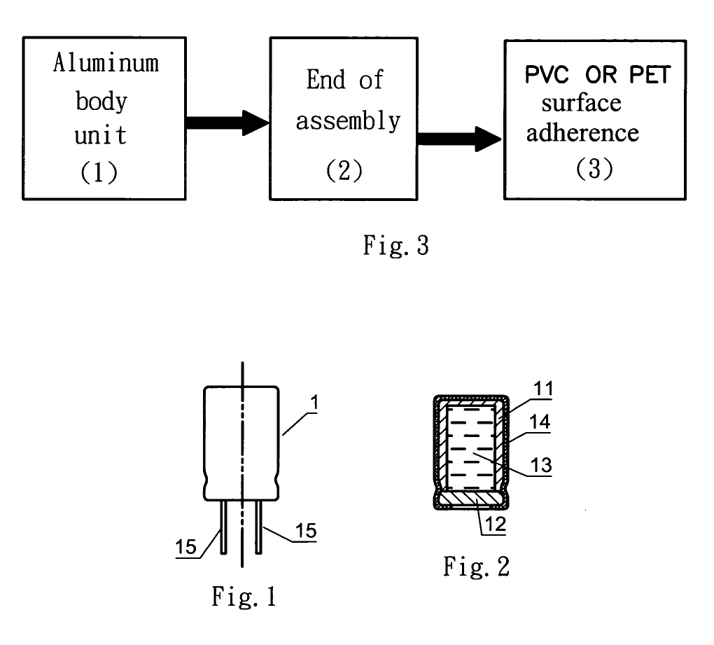

### DETAILED DESCRIPTION OF THE PREFERRED EMBODIMENTS

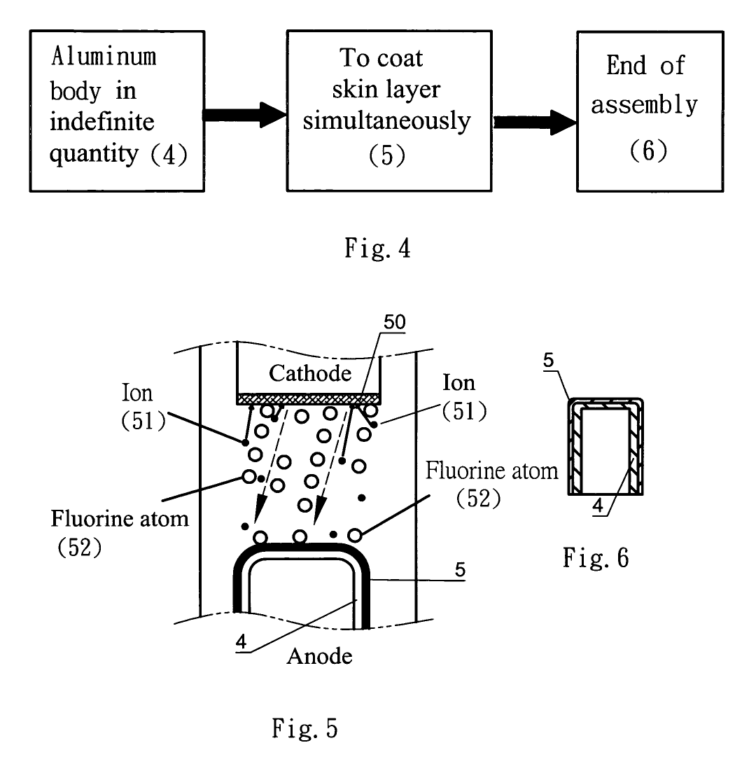

Please refer to FIG. 4 and FIG. 5, which place polytetrafluoroethylene (50) at cathode first and aluminum body of electrolytic capacity (4) in indefinite quantity at anode in a high vacuum electric field or electric plasma box as well, gaseous ion (51) inside may strike polytetrafluoroethylene)(50) at cathode based on the high electric potential difference between the electrodes, so that it may strike out fluorine atom (52) inside, meanwhile, fluorine atom (52) at anode may be oxidized and produce strong adherence, which then deposit on surface of aluminum body of electrolytic capacitor so as to form skin layer (5) in 10μ˜15μ thick, which may insulate and protect surface of aluminum body, therefore, it can directly and quickly coat surface of aluminum body (4) for purpose of insulation (such as FIG. 6), but no need to pack aluminum body with PVC or PET, it can be directly combined with plastic gasket (12) (as shown in the current FIG. 2 )and fill electrolyte (13) at end of coating, the finished product is then assembled (6) at this moment, so, this method can save the assembling flow and man-hour of electrolytic capacity, furthermore, this coating method of aluminum body of this invention is in conformity with requirements of environmental protection, so, it is impossible to produce the second pollution.

The above described method can also be applicable to this executive example, namely, to place polytetrafluoroethylene in ultra high vacuum box first and produce ion source with microwave generator, control electric field according to size of microwave, so that electron can produce cyclotron resonance discharge and also produce high energy ion beam (51) to strike polytetrafluoroethylene (50), fluorine atom (52) is oxidized at anode and produce strong adherence that can adhere to surface of aluminum body (4) of electrolytic capacitor in indefinite quantity and form skin layer (5) in suitable thickness, the favorite thickness of skin layer (5) is 10μ˜15μ, which can insulate and protect surface of aluminum body of electrolytic capacitor. Therefore, this method can provide quick coating and answer to requirements of environmental protection.

To sum up all above descriptions, with polytetrafluoroethylene as material, this invention applies ion to strike out fluorine atom, which coats on surface of aluminum body of electrolytic capacity so as to directly produce quick insulation and protection, therefore, this method has already answered to requirements of patent that is progressive and practical in the industry, furthermore, there isn't any public data about the method published before application of this invention, thereby, it is in conformity with the authorizing provisions of patent.

What is claimed is:

1. A method to coat insulation film on aluminum body of electrolytic capacitor, which includes the following:
a. To place polytetrafluoroethylene at cathode first in the high vacuum electric field or electric plasma box and aluminum body of electrolytic capacitor at anode as well.
b. To strike polytetrafluoroethylene at cathode with gaseous ion so as to strike out fluorine atom inside;
c. Fluorine atom at anode may be oxidized and produce strong adherence, then deposit on surface of aluminum body of electrolytic capacitor so as to form skin layer, which may insulate and protect surface of aluminum body;
Therefore, this coating method can directly and quickly coat surface of aluminum body but no need to pack aluminum body with PVC or PET, so, it can save the assembling flow and man-hour of electrolytic capacity and answer to requirements of environmental protection, so, it is impossible to produce the second pollution.

2. A method to coat insulation film on aluminum body of electrolytic capacitor, which includes the following:
a. To place polytetrafluoroethylene in the ultra high vacuum box;
b. To produce ion source with microwave generator, control electric field according to size of microwave, so that electron can produce cyclotron resonance discharge, and also produce high energy ion beam (51) to strike polytetrafluoroethylene (50).
c. Let fluorine atom oxidize at anode and produce strong adherence that can adhere to surface of aluminum body of electrolytic capacitor and form skin layer in suitable thickness;
Therefore, based on above described coating method, which can insulate and protect surface of aluminum body of electrolytic capacitor, and also can coat insulation film quickly and answer to requirements of environmental protection.

3. As claimed in claim 1, which is a method to coat insulation film on aluminum body of electrolytic capacitor, wherein this ion is generated in the high vacuum electric field or electric plasma based on high potential difference between anode and cathode.

4. As claimed in claim 2, which is a method to coat insulation film over aluminum body of electrolytic capacitor, wherein this ion is generated in the high vacuum box, and produce ion source with microwave generator.

5. As claimed in claim 1 or claim 2, which is a method to coat insulation film on aluminum body of electrolytic capacitor, wherein it can coat insulation film on aluminum body indefinite quantity.
